(19) United States
(12) Patent Application Publication
(10) Pub. No.: US 2023/0180004 A1
(43) Pub. Date: Jun. 8, 2023

(54) 5G SMART FACTORY REPLAY ATTACK DETECTION METHOD AND APPARATUS

(71) Applicant: WINS Co., Ltd., Seongnam-si (KR)

(72) Inventors: Yong Sig JIN, Yongin-si (KR); Jong Gu LEE, Seongnam-si (KR)

(21) Appl. No.: 17/811,540

(22) Filed: Jul. 8, 2022

(30) Foreign Application Priority Data
Dec. 6, 2021 (KR) 10-2021-0172914

(51) Int. Cl. H04W 12/121; H04W 12/06

(52) U.S. Cl. CPC H04W 12/121; H04W 12/06

(57) ABSTRACT

A 5G smart factory replay attack detection method includes (A) acquiring and managing, by a 5G smart factory replay attack detection apparatus, user information including IP information assigned to a user terminal, (B) acquiring factory facility command data based on user data in a GTP-U protocol between a 5G base station and a user plane function (UPF), and managing the acquired factory facility command data as an authentication command for each user terminal, (C) acquiring the factory facility command data and user terminal IP information based on the user data, (D) comparing the factory facility command data and the user terminal IP information with the authentication command for each user terminal and the IP information acquired in the (A) acquiring and managing of the user information, respectively, and (E) detecting an attack based on the command comparison result and the IP information comparison result.

### CROSS-REFERENCE TO RELATED APPLICATION(S)

This application is based on and claims priority under 35 U.S.C. 119 to Korean Patent Application No. 10-2021-0172914, filed on Dec. 6, 2021, in the Korean Intellectual Property Office, the disclosure of which is herein incorporated by reference in its entirety.

### BACKGROUND OF THE INVENTION

### 1. Field of the Invention

The disclosure relates to a method for detecting a replay attack made by an attacker in a 5G smart factory to acquire an administrator right by retransmitting communication data of a control system and a facility.

### 2. Description of the Prior Art

A smart factory refers to an intelligent factory capable of improving productivity, quality, customer satisfaction, and the like by applying information communication technology to the entire production process including design and development, manufacturing, and distribution. A 5G smart factory refers to a smart factory constructed by using 5G technology.

FIG. 1 illustrates a basic construction of a 5G smart factory.

Factory production facilities 100_1 to 100_6 are connected to a 5G IoT base station 104 and a 5G core network 102 through embedded 5G communication terminal devices, and are operated through a remote Human Machine Interface (HMI) 106 for remote manipulation and the like with a service server 108 (monitoring, control server).

5G has super-fast, super-low latency, and super-connectivity characteristics and can support response rates, processing capability, mutual operation with external networks, super-connectivity coverage, and expandability required by smart factories, thereby making it possible to expect productivity and quality improvement and other remarkable achievements.

Meanwhile, communication protocols used by manufacturing facilities use dedicated communication protocols for communication, not generic TCP/IP. Due to closed environments of factory facilities, dedicated communication protocols are designed without considering security such that communication is performed without encrypting and authenticating messages, and thus are known to be vulnerable to man-in-the-middle attacks and replay attacks (for example, message forgery).

Such threats have surfaced due to the communication openness of smart factories, and security accidents have recently occurred continuously.

A replay attack refers to a method in which a protocol-based message is copied and retransmitted to impersonate an authorized user. Methods for thwarting replay attacks are as follows: a sequence number is used to manage the communication sequence number, thereby thwarting replay attacks; a timestamp is used such that message start information synchronizes the transmitter/receiver; or a disposable random value is transmitted to the transmitter such that a message authentication code (MAC) value is calculated by combining a message and a nonce, and the nonce value is replaced for each communication time.

However, communication protocols used in factory facilities are not designed to apply such techniques, making defense difficult. In addition, due to characteristics of factory facilities, facilities are equipped with embedded software designed to perform only a specific function (for example, RTOS), making it difficult to install additional security functions.

In addition, not only technical problems, but also operational problems (for example, low level of understanding of security by production managers, no security countermeasure solution installed) place restrictions on identifying and handling threats.

Therefore, there is a need for a technology for detecting a replay attack made by an attacker in a 5G smart factory to acquire an administrator right by retransmitting communication data of a control system and a facility.

### SUMMARY OF THE INVENTION

A problem to be solved by the disclosure is to provide a method and an apparatus for detecting 5G smart factory replay attacks, wherein replay attacks can be detected in a 5G smart factory.

Another problem to be solved by the disclosure is to provide a method and an apparatus for detecting 5G smart factory replay attacks, wherein user authentication information in a GTP tunnel generating step of 5G communication and communication data of a factory facility through a GTP tunnel are connected so as to prevent acquisition of an administrator right through replay attacks.

Another problem to be solved by the disclosure is to provide a method and an apparatus for detecting 5G smart factory replay attacks, wherein attacks are prevented through user management technology through communication of GTP tunnel generation (management of assigned IP and transmittable commands on a per terminal basis), communication data analysis technology (GTP-U, Modbus, or OPC UA) of facilities through a generated GTP tunnel, and command control of a terminal defined through command definition technology of communication data.

Another problem to be solved by the disclosure is to provide a method and an apparatus for detecting 5G smart factory replay attacks, wherein in a recent problematic situation in which communication protocols having poor security are used in smart factories due to inherent limits of factory facilities (embedded software installed, closed environments, and the like), thereby exposing threats, replay attacks can be detected through a terminal authentication function and used command management, without improving expensive communication protocols by connecting with characteristics of 5G communication.

In order to solve the above-mentioned problems, a 5G smart factory replay attack detection method according to an embodiment of the disclosure includes: (A) acquiring and managing, by a 5G smart factory replay attack detection apparatus, user information including IP information assigned to a user terminal when a GTP tunnel is generated through communication data between an access and mobility management function (AMF) and a session management function (SMF) in a 5G core network; (B) acquiring factory facility command data based on user data in a GTP-U protocol between a 5G base station and a user plane function (UPF), and managing the acquired factory facility command data as an authentication command for each user terminal; (C) acquiring factory facility command data and user terminal IP information based on the user data in the GTP-U protocol between the 5G base station and the UPF; (D) comparing the factory facility command data and the user terminal IP information acquired in the (C) acquiring of the factory facility command data with the authentication command for each user terminal and the IP information acquired in the (A) acquiring and managing of the user information, respectively; and (E) detecting an attack based on the command comparison result and the IP information comparison result.

In connection with the 5G smart factory replay attack detection method according to an embodiment of the disclosure, the user information may include terminal identification information, the IP information assigned to the user terminal, and generated GTP tunnel information.

In addition, in connection with the 5G smart factory replay attack detection method according to an embodiment of the disclosure, the (B) acquiring of the factory facility command data includes storing the acquired factory facility command data for each of the corresponding user terminal identification numbers based on the user information generated when the GTP tunnel is generated.

In addition, in connection with the 5G smart factory replay attack detection method according to an embodiment of the disclosure, the (E) detecting of the attack may include outputting an attack detection signal indicating that the attack is detected when the command related data acquired in the (C) acquiring of the factory facility command data and the authentication command for each user terminal are different or when the user terminal IP information acquired in the (C) acquiring of the factory facility command data and the IP information acquired in the (A) acquiring and managing of the user information are different.

In addition, in connection with the 5G smart factory replay attack detection method according to an embodiment of the disclosure, the factory facility command data may include a function code in a Modbus protocol or a message type in an OPC unified architecture (OPC UA) protocol.

A 5G smart factory replay attack detection apparatus according to an embodiment of the disclosure includes: a user information acquisition and management unit configured to acquire and manage user information including IP information assigned to a user terminal when a GTP tunnel is generated through communication data between an AMF and a SMF in a 5G core network; a command acquisition unit configured to acquire factory facility command data based on user data in a GTP-U protocol between a 5G IoT base station and a UPF; a command management unit configured to manage the factory facility command data acquired by the command acquisition unit as an authentication command for each user terminal; an IP information acquisition unit configured to acquire user terminal IP information based on the user data in the GTP-U protocol between the 5G IoT base station and the UPF; a command comparison unit configured to compare the command data acquired by the command acquisition unit with authentication commands for each user terminal; an IP information comparison unit configured to compare the user terminal IP information obtained by the IP information acquisition unit with the IP information acquired by the user information acquisition and managing unit; and an attack detection unit configured to detect an attack based on an output of the command comparison unit and an output of the IP information comparison unit.

In connection with the 5G smart factory replay attack detection apparatus according to an embodiment of the disclosure, the user information may include terminal identification information, the IP information assigned to the user terminal, and generated GTP tunnel information.

In addition, in connection with the 5G smart factory replay attack detection apparatus according to an embodiment of the disclosure, the command management unit may store the factory facility command data acquired by the command acquisition unit for each of the corresponding user terminal identification numbers based on the user information generated when the GTP tunnel is generated.

In addition, in connection with the 5G smart factory replay attack detection apparatus according to an embodiment of the disclosure, the attack detection unit may output an attack detection signal indicating that the attack is detected when the command data acquired by the command acquisition unit and the authentication command for each user terminal are different or when the user terminal IP information acquired by the IP information acquisition unit and the IP information acquired by the user information acquisition and management unit are different.

In addition, in connection with the 5G smart factory replay attack detection apparatus according to an embodiment of the disclosure, the factory facility command data may include a function code in a Modbus protocol or a message type in an OPC unified architecture (OPC UA) protocol.

A method and an apparatus for detecting a 5G smart factory replay attack according to an embodiment of the disclosure may detect replay attacks in a 5G smart factory.

In addition, a method and an apparatus for detecting a 5G smart factory replay attack according to an embodiment of the disclosure may detect replay attacks through a terminal authentication function and used command management, without improving expensive communication protocols by connecting with characteristics of 5G communication, in a recent problematic situation in which communication protocols having poor security are used in smart factories due to inherent limits of factory facilities (embedded software installed, closed environments, and the like), thereby exposing threats.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a basic configuration of a general 5G smart factory.

FIG. 2 is a diagram illustrating a configuration of general 5G mobile communication.

FIG. 3 is a diagram illustrating a 5G smart factory replay attack detection apparatus according to an embodiment of the disclosure.

FIG. 4 is a flowchart illustrating a 5G smart factory replay attack detection method according to an embodiment of the disclosure.

FIGS. 5A and 5B are diagrams illustrating a Modbus communication structure.

FIG. 6 is a diagram illustrating an OPC UA communication structure.

FIG. 7 is a diagram illustrating exemplary authentication commands for each user terminal stored in an authentication command storage unit for each user terminal.

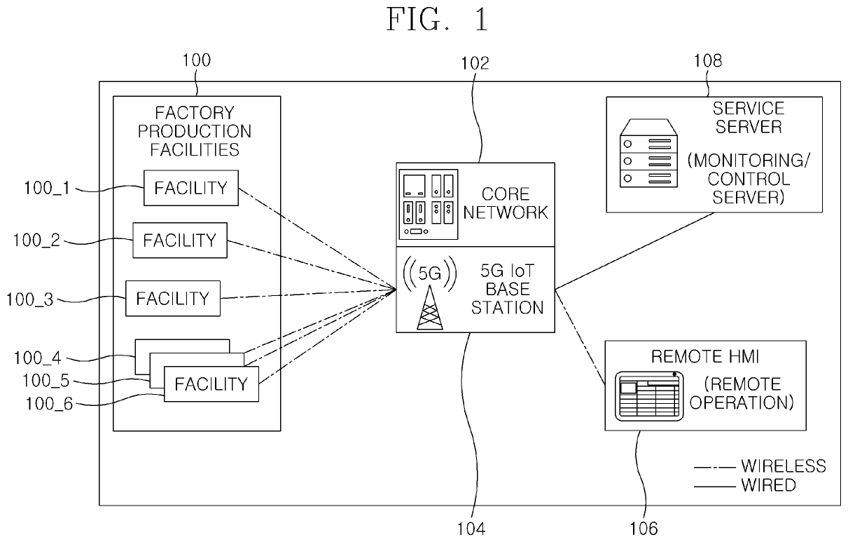

### DETAILED DESCRIPTION OF THE EXEMPLARY EMBODIMENTS

The objects, specific advantages and novel features of the disclosure will become more apparent from the following detailed description taken in conjunction with the accompanying drawings and preferred embodiments.

Prior to this, terms or words used in the present specification and claims should not be construed as being limited to conventional or dictionary meanings, and should be interpreted as a meaning and concept consistent with the technical idea of the disclosure based on the principle that the inventor may appropriately define the concept of a term to describe his invention in the best way.

In the present specification, in adding reference numbers to the components of each drawing, it should be noted that only the same components are given the same number as possible even though they are indicated on different drawings.

In addition, terms such as “first”, “second”, “one side”, and “other side” are used to distinguish one component from another component, and the components are not limited by the above terms.

Hereinafter, in describing the disclosure, detailed descriptions of related known technologies that may unnecessarily obscure the gist of the disclosure will be omitted.

Hereinafter, preferred embodiments of the disclosure will be described in detail with reference to the accompanying drawings.

Mobile communication technology refers to a communication system in which mobility is granted so that communication of voice, video, data, etc., is performed by a user through a terminal regardless of locations, and supports user authentication and integrity.

In each facility of a 5G smart factory, communication is performed through a base station and a core network by using a built-in 5G communication terminal device. Here, after being subjected to and passing user authentication to access the core network, data communication can be performed when a GTP tunnel is generated.

The 5G smart factory replay attack detection method and apparatus according to an embodiment of the disclosure are to prevent the acquisition of administrator privileges through replay attacks by connecting user authentication information of the GTP tunnel generation stage of 5G communication with the communication data of the factory facilities through the GTP tunnel. Here, attacks are prevented through user management technology through communication of GTP tunnel generation (management of assigned IP and transmittable commands on a per terminal basis), communication data analysis technology (GTP-U, Modbus, or OPC UA) of facilities through a generated GTP tunnel, and command control of a terminal defined through command definition technology of communication data.

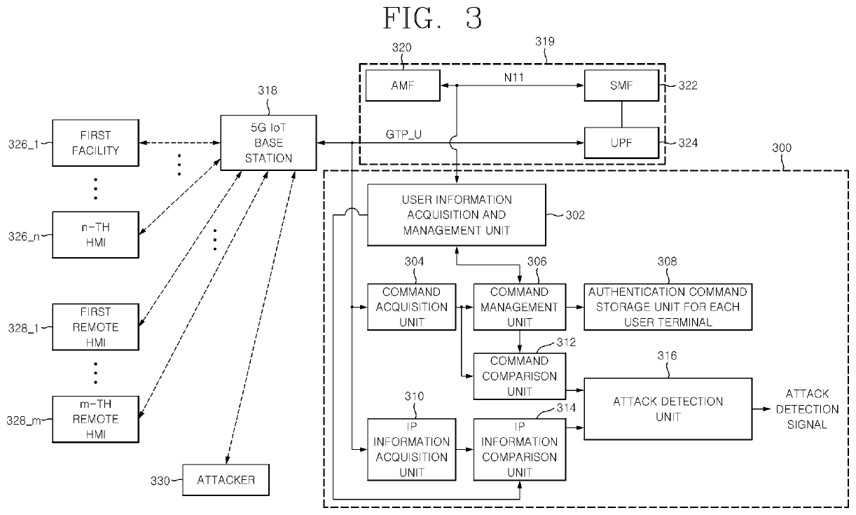

Referring to FIG. 3, a 5G smart factory replay attack detection apparatus 300 according to an embodiment of the disclosure includes a user information acquisition and management unit 302 configured to acquire user information including IP information assigned to a user terminal when a GTP tunnel is generated through communication data between an access and mobility management function (AMF) 320 and a session management function (SMF) 322 within a 5G core network 319 and to store the acquired user information in an authentication command storage unit 308 for each user terminal, a command acquisition unit 304 configured to acquire factory facility command data based on user data in a GTP-U protocol between a 5G IoT base station 318 and a user plane function (UPF) 324, a command management unit 306 configured to manage the factory facility command data acquired by the command acquisition unit 304 as an authentication command for each user terminal, an IP information acquisition unit 310 configured to acquire user terminal IP information based on the user data in the GTP-U protocol between the 5G IoT base station 318 and the user plane function (UPF) 324, a command comparison unit 312 configured to compare the command data acquired by the command acquisition unit 304 with authentication commands for each user terminal stored in the authentication command storage unit 308 for each user terminal, an IP information comparison unit 314 configured to compare the user terminal IP information obtained by the IP information acquisition unit 310 with the IP information obtained by the user information acquisition and managing unit 302, and an attack detection unit 316 configured to detect a replay attack of an attacker 330 based on an output of the command comparison unit 312 and an output of the IP information comparison unit 314.

In the disclosure, first to n-th facilities 326_1 to 326_n and first to m-th remote HMIs 328_1 to 328_m illustrated in FIG. 3 each includes a 5G communication terminal device.

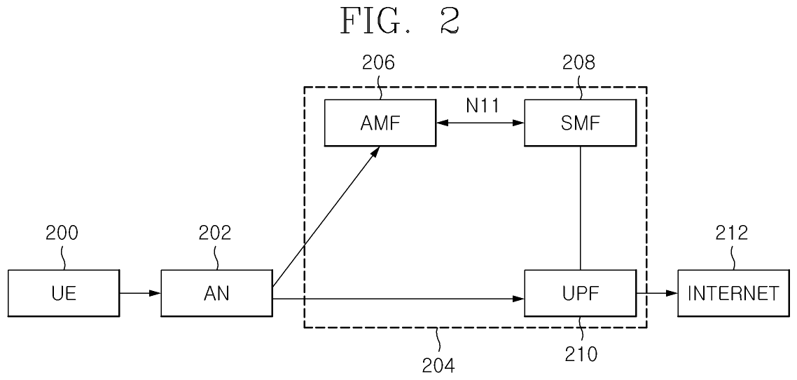

FIG. 2 illustrates a configuration of a general 5G mobile communication system, and includes a base station 202 and a 5G core network 204. The 5G core network 204 includes an access and mobility management function (AMF) 206, a session management function (SMF) 208, and a user plane function (UPF) 210. Reference numeral 200 denotes a user terminal, and reference numeral 212 denotes an Internet network, which is a data network.

Typically, in a 5G smart factory, each facility and each remote HMI with a built-in 5G communication terminal device exists inside the smart factory as a user terminal, and communicates with a base station inside the smart factory through a 5G core network. Therefore, in the 5G smart factory, a 5G communication system is constructed in a configuration excluding the connection to the Internet 212 illustrated in FIG. 2. Accordingly, in the 5G system of FIG. 3, it is illustrated that a connection between the Internet and the UPF 324 does not exist.

Referring again to FIG. 2, in 5G mobile communication, the user terminal 200 generates a GTP tunnel after passing user authentication through communication between the AMF 206 and the SMF 208 through the base station 202.

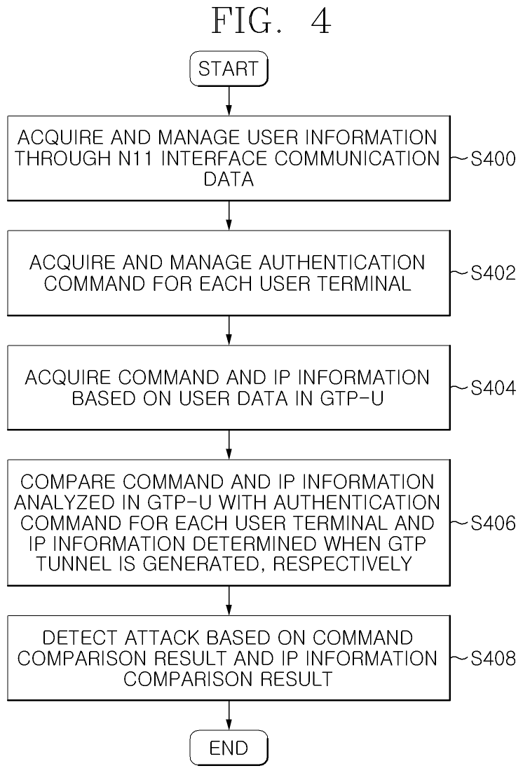

Accordingly, referring to FIGS. 3 and 4, in operation S400, the user information acquisition and management unit 302 acquires and manages user information of the GTP tunnel generation operation in the 5G core network 319 of 5G mobile communication.

That is, in operation S400, the user information acquisition and management unit 302 acquires and manages user information including IP information assigned to the user terminal when the GTP tunnel is generated through N11 interface communication data between the AMF 320 and the SMF 322 in the 5G core network 319, a user terminal identification number, and the generated GTP tunnel information.

Specifically, in operation S400, the user information acquisition and management unit 302 acquires and manages the user information including the IP information assigned to each of the first to n-th facilities 326_1 to 326_n and the first to m-th remote HMIs 328_1 to 328_m when the GTP tunnel is generated through the N11 interface communication data between the AMF 320 and the SMF 322, the user terminal identification number, and the generated GTP tunnel information.

In operation S402, the command acquisition unit 304 acquires factory facility command data based on user data in the GTP-U protocol between the 5G IoT base station 318 and the user plane function (UPF) 324, and the command management unit 306 stores and manages, in the authentication command storage unit 308 for each user terminal, the factory facility command data acquired by the command acquisition unit 304 based on the user information stored in the user information acquisition and management unit 302 as an authentication command for each user terminal.

Communication of the user terminal connected to the 5G core network 319 is performed through the generated GTP tunnel, and a protocol used at this time is a GTP-U. On the other hand, the GTP-U protocol includes a Modbus protocol and an object linking and embedding for process control (OPC) united architecture (UA) protocol to be dealt with in the disclosure among factory facility communication protocols.

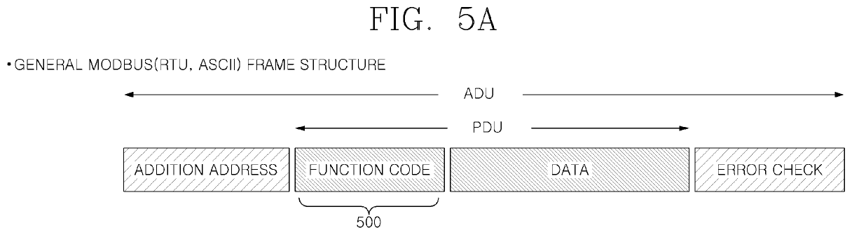

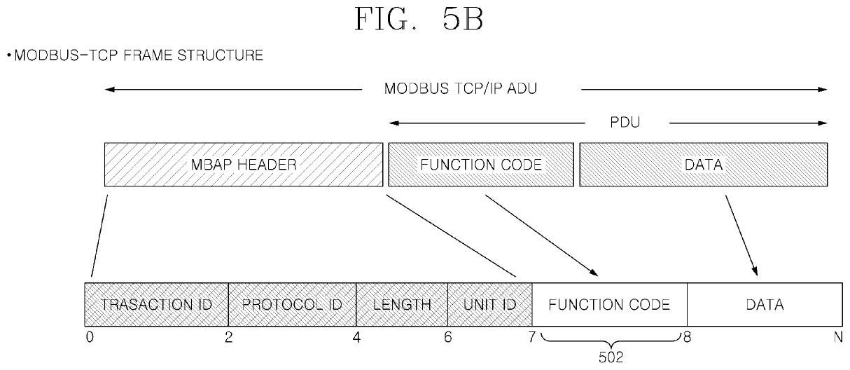

A Modbus communication protocol, which is a command management technology of Modbus, is illustrated in FIGS. 5A and 5B. The command acquisition unit 304 acquires function codes 500 and 502 of the Modbus communication protocol from communication data, and the command management unit 306 stores the acquired function codes in the authentication command storage unit 308 for each user terminal as an authentication command for each user terminal.

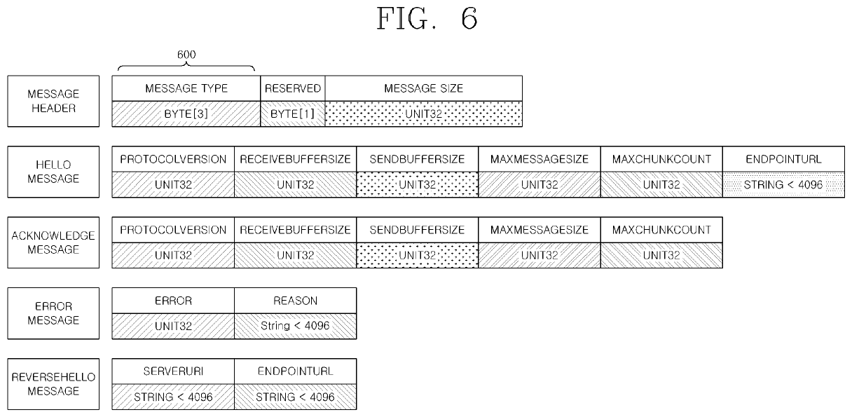

A communication protocol of OPC UA, which is a command management technology of OPC UA, is illustrated in FIG. 6. The command acquisition unit 304 acquires a message type 600 of the communication protocol of OPC UA from communication data, and the command management unit 306 stores the acquired message type in the authentication command storage unit 308 for each user terminal as the authentication command for each user terminal.

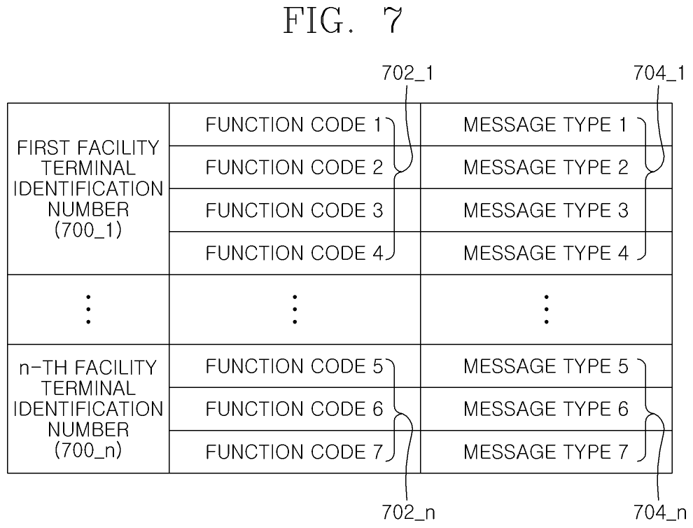

Specifically, in operation S402, the command acquisition unit 304 acquires the function codes 500 and 502 in the Modbus communication protocol or the message type 600 in the OPC UA communication protocol based on the user data in the GTP-U protocol between the 5G IoT base station 318 and the UPF 324, that is, the communication data between the first to n-th facilities 326_1 to 326_n and the first to m-th remote HMIs 328_1 to 328_m, and the command management unit 306 registers and stores, in the authentication command storage unit 308 for each user terminal, the function codes 500 and 502 or the message type 600 acquired by the command acquisition unit 304 as the authentication command for each user terminal for the corresponding first to n-th facilities 326_1 to 326_n based on the user information stored in the user information acquisition and management unit 302, whereby Modbus usage commands and OPC UA usage commands analyzed in the GTP-U protocol are stored and managed for each user terminal as illustrated in FIG. 7.

FIG. 7 is a diagram illustrating exemplary authentication commands for each user terminal stored in the authentication command storage unit 308 for each user terminal. The commands for each registered user terminal illustrated in FIG. 7 may be verified by an administrator, and the verified commands may be managed as authentication commands.

In FIG. 7, reference numerals 700_1 to 700_n denote first to n-th facility terminal identification numbers, and reference numerals 702_1 to 702_n denote function codes corresponding to the first to n-th facility terminal identification numbers 700_1 to 700_n, respectively. Reference numerals 704_1 to 704_n denote message types corresponding to the first to n-th facility terminal identification numbers 700_1 to 700_n, respectively.

As illustrated in FIG. 7, exemplarily, four pieces of corresponding command data 702_1 and 704_1 are stored in the terminal identification number 700_1 of the first facility 326_1, and three pieces of corresponding command data 702_n and 704_n are stored in the terminal identification number 700_n of the n-th facility 326_n. FIG. 7 is an exemplary diagram, the disclosure is not limited thereto, and the number of pieces of command data corresponding to each facility may be less or more than the above-mentioned number.

In the subsequent operation, by tracking the GTP tunnel generated through user information management in the GTP tunnel generation operation, communication data according to the communication protocol of the GTP-U is analyzed through the GTP tunnel generated between the 5G IoT base station 318 and the UPF 324, thereby detecting whether the attacker 330 performs an attack through the Modbus usage command, OPC UA usage command, and used IP for each user terminal. That is, when a difference occurs by comparing the command and IP information analyzed in the GTP-U with the authenticated command and the IP information determined in the GTP tunnel generation, respectively, an attack detection occurs.

In the communication protocol of the GTP-U, data of the first to n-th factory facilities 326_1 to 326_n are encapsulated in the GTP-U and communicated, and the IP information may be acquired and managed by analyzing IP frames of the first to n-th factory facilities 326_1 to 326_n. In operation S404, the command acquisition unit 304 acquires factory facility command data based on the user data in the GTP-U protocol between the 5G IoT base station 318 and the UPF 324, and the IP information acquisition unit 310 acquires user terminal IP information assigned to the user terminal based on the user data in the GTP-U protocol between the 5G IoT base station 318 and the UPF 324.

In operation S406, the command comparison unit 312 compares the factory facility command data acquired in operation S404 with the authentication commands for each user terminal stored in the authentication command storage unit 308 for each user terminal.

For example, when the attacker 330 transmits command data of Function code 8 to the first facility 326_1, the factory facility command data acquired by the command acquisition unit 304 in operation S404 is Function code 8, and the command comparison unit 312 compares Function code 8 which is the factory facility command data acquired in operation S404 with authentication commands (Function code 1, Function code 2, Function code 3, and Function code 4) for each user terminal corresponding to the first facility terminal identification number 700_1 stored in the authentication command storage unit 308 for each user terminal.

As illustrated in FIG. 7, since only corresponding Function code 1, Function code 2, Function code 3, and Function code 4 exist in the first facility terminal identification number 700_1, it is understood that the first facility 326_1 does not use Function code 8. Accordingly, in this case, the command comparison unit 312 outputs a signal indicating that there is a difference in the command comparison results.

In addition, in operation S406, the IP information comparison unit 314 compares the IP information acquired by the IP information acquisition unit 310 in operation S404 with the IP information determined when the GTP tunnel is generated in operation S400.

For example, when the IP information determined when the GTP tunnel is generated in operation S400 is 1.1.1.1 and the attacker 330 performs a replay attack, the IP information of the attacker 330 may be 1.1.1.2. Accordingly, in operation S406, the IP information comparison unit 314 outputs a signal indicating that there is a difference in the IP information comparison results.

The attack detection unit 316 detects an attack based on the command comparison result and the IP information comparison result.

That is, when there is the difference both in the command comparison results and the IP information comparison results, the attack detection unit 316 outputs a signal indicating that an attack is detected.

Alternatively, the attack detection unit 316 outputs the signal indicating that the attack is detected when there is the difference in the command comparison results or there is the difference in the IP information comparison results.

Although the disclosure has been described in detail through specific embodiments, it is intended to describe the disclosure in detail, and the disclosure is not limited thereto. It will be apparent that modifications or improvements are possible by those of ordinary skill in the art within the technical spirit of the disclosure.

All simple modifications and variations of the disclosure fall within the scope of the disclosure, and the specific scope of protection of the disclosure will become apparent from the appended claims.

[Brief Description of Reference Numerals]

| | |
|---|---|
| 100_1 to 100_6: Factory production facilities | |
| 102: 5G core network | 104, 318: 5G IoT |
| | base stations |
| 106: Remote HMI | 108: Service server |
| 200: User terminal | 202: Base station |
| 204: 5G core network | 206, 320: AMF |
| 208, 322: SMF | 210, 324: UPF |
| 212: Internet | |
| 300: 5G smart factory replay attack | |
| detection apparatus | |
| 302: User information acquisition and | |
| management unit | |
| 304: Command acquisition unit | |
| 306: Command management unit | |
| 308: Authentication command storage unit | |
| for each user terminal | |
| 310: IP information acquisition unit | |
| 312: Command comparison unit | |
| 314: IP information comparison unit | |
| 316: Attack detection unit | |
| 326_1 to 326_n: First to n-th facilities | |
| 328_1 to 328_m: First remote HMI to m-th | |
| remote HMI | |
| 330: Attacker | 500, 502: Function |
| | codes |
| 600: Message type | |
| 700_1 to 700_n: First to n-th facility terminal | |
| identification numbers | |
| 702_1 to 702_n: Function codes corresponding | |
| to first to n-th facility terminal identification | |
| numbers, respectively | |
| 704_1 to 704_n: Message types corresponding | |
| to first to n-th facility terminal identification | |
| numbers, respectively | |

What is claimed is:

1. A 5G smart factory replay attack detection method comprising:
(A) acquiring and managing, by a 5G smart factory replay attack detection apparatus, user information including IP information assigned to a user terminal when a GTP tunnel is generated through communication data between an access and mobility management function (AMF) and a session management function (SMF) in a 5G core network;
(B) acquiring factory facility command data based on user data in a GTP-U protocol between a 5G base station and a user plane function (UPF), and managing the acquired factory facility command data as an authentication command for each user terminal;
(C) acquiring factory facility command data and user terminal IP information based on the user data in the GTP-U protocol between the 5G base station and the UPF;
(D) comparing the factory facility command data and the user terminal IP information acquired in the (C) acquiring of the factory facility command data with the authentication command for each user terminal and the IP information acquired in the (A) acquiring and managing of the user information, respectively; and
(E) detecting an attack based on the command comparison result and the IP information comparison result.

2. The 5G smart factory replay attack detection method of claim 1, wherein the user information includes terminal identification information, the IP information assigned to the user terminal, and generated GTP tunnel information.

3. The 5G smart factory replay attack detection method of claim 2, wherein the (B) acquiring of the factory facility command data includes storing the acquired factory facility command data for each of the corresponding user terminal identification numbers based on the user information generated when the GTP tunnel is generated.

4. The 5G smart factory replay attack detection method of claim 1, wherein the (E) detecting of the attack includes outputting an attack detection signal indicating that the attack is detected when the command related data acquired in the (C) acquiring of the factory facility command data and the authentication command for each user terminal are different or when the user terminal IP information acquired in the (C) acquiring of the factory facility command data and the IP information acquired in the (A) acquiring and managing of the user information are different.

5. The 5G smart factory replay attack detection method of claim 1, wherein the factory facility command data includes a function code in a Modbus protocol or a message type in an OPC unified architecture (OPC UA) protocol.

6. A 5G smart factory replay attack detection apparatus comprising:
a user information acquisition and management unit configured to acquire and manage user information including IP information assigned to a user terminal when a GTP tunnel is generated through communication data between an AMF and a SMF in a 5G core network;
a command acquisition unit configured to acquire factory facility command data based on user data in a GTP-U protocol between a 5G IoT base station and a UPF;
a command management unit configured to manage the factory facility command data acquired by the command acquisition unit as an authentication command for each user terminal;
an IP information acquisition unit configured to acquire user terminal IP information based on the user data in the GTP-U protocol between the 5G IoT base station and the UPF;
a command comparison unit configured to compare the command data acquired by the command acquisition unit with authentication commands for each user terminal;
an IP information comparison unit configured to compare the user terminal IP information obtained by the IP information acquisition unit with the IP information acquired by the user information acquisition and managing unit; and
an attack detection unit configured to detect an attack based on an output of the command comparison unit and an output of the IP information comparison unit.

7. The 5G smart factory replay attack detection apparatus of claim 6, wherein the user information includes terminal identification information, the IP information assigned to the user terminal, and generated GTP tunnel information.

8. The 5G smart factory replay attack detection apparatus of claim 7, wherein the command management unit stores the factory facility command data acquired by the command acquisition unit for each of the corresponding user terminal identification numbers based on the user information generated when the GTP tunnel is generated.

9. The 5G smart factory replay attack detection apparatus of claim 6, wherein the attack detection unit outputs an attack detection signal indicating that the attack is detected when the command data acquired by the command acquisition unit and the authentication command for each user terminal to are different or when the user terminal IP information acquired by the IP information acquisition unit and the IP information acquired by the user information acquisition and management unit are different.

10. The 5G smart factory replay attack detection apparatus of claim 6, wherein the factory facility command data includes a function code in a Modbus protocol or a message type in an OPC UA protocol.
